(19) United States
(12) Patent Application Publication
(10) Pub. No.: US 2017/0172318 A1
(43) Pub. Date: Jun. 22, 2017

(54) FURNITURE SYSTEM

(71) Applicant: BDA Engineering Pte Ltd., Singapore (SG)

(72) Inventor: Wah Chie Wang, Singapore (SG)

(21) Appl. No.: 15/118,258

(22) PCT Filed: Feb. 11, 2015
(86) PCT No.: PCT/SG2015/000041

§ 371 Date: Aug. 11, 2016

(30) Foreign Application Priority Data
Feb. 13, 2014 (SG) 2014014401

(51) Int. Cl. A47F 5/10; G06Q 30/06; A47B 57/54; A47B 96/14; A47B 47/00; A47B 57/34

(52) U.S. Cl. CPC A47F 5/10; A47B 47/0091; A47B 57/34; A47B 57/545; A47B 96/1466; A47F 5/101; G06Q 30/0601

(57) ABSTRACT

The present invention relates to a modular furniture system for displaying and storing articles, which is particularly suitable for being erected in shops, at home or in industrial companies, e.g. in an industrial store. In particular, it relates to a modular furniture system comprising: (a) a first panel having at least one track on a surface of the panel, the track running the length of the panel; (b) a display or storage means adapted to slide along the length of the track; and (c) a fastening means for securing the display or storage means at a desired position along the track.

### FIELD OF THE INVENTION

A furniture system for displaying and storing articles, which is particularly suitable for being erected in shops, at home or in industrial companies, e.g. in an industrial store. In particular, the present invention may be a modular system that provides components for a furniture system suitable for the display and storage of items for sale at a retail store. In addition, the present invention system may also be a kit for assembly of customizable and adjustable furniture that may be ideally suited for commercial use in the display and storage of items for sale in a store.

### BACKGROUND OF THE INVENTION

In retail stores, clothing and goods for sale are displayed on racks or shelves. In some instances, clothing may be displayed on arms that protrude either from a wall or from a stand. Garments are typically hung from hangers, which are then suspended from these arms. The arms are either straight poles or are equipped with dividers to space out the hangers and garments to ensure all garments are visible. The arms protrude substantially horizontally or at a pre-determined angle, so that all of the garments on the arm may be seen, including those at the rear.

When the types of garments to be displayed need to be changed or when there is a need to change the layout arrangement of the display in the store, the arms or shelves are removed from the wall or stand and the required type of arm, i.e. horizontal or angled, is attached. This can be time consuming and requires a retail store to have a number of different arms in storage for attachment as needed. There may be times when it is thought that a particular garment would be best displayed horizontally, and then once the arm is changed and the garments are suspended, it is realised that an angled arm would be better. The garments then need to be removed and the arm changed again.

It is therefore an object of the present invention to provide a furniture system that at least in part alleviates some of the problems associated with current systems.

### SUMMARY OF THE INVENTION

In a first aspect of the invention, there is provided a modular furniture system comprising: (a) a first panel having at least one track on a surface of the panel, the track running the length of the panel; (b) a display or storage means adapted to slide along the length of the track; and (c) a fastening means for securing the display or storage means at a desired position along the track.

Preferably, the system according to claim 1, further comprising: (a) a second panel opposing the first panel; (b) the second panel having at least one track on a surface that opposes the track of the first panel, the track running the length of the panel; and (c) the display or storage means extends between the first and second panels.

Preferably, the first and second panels further comprising a plurality of tracks on the surface that opposes each other, each track is adapted to receive at least one display or storage means, wherein the display or storage means is adapted to slide along the length of the track.

Preferably, each first and second panels comprising three tracks, the positions of the tracks on the first panel correspond to those positions of the tracks on the opposing second panel.

Preferably, one track is positioned in the center of the panel, one track is positioned near a front edge of the panel, and one track is positioned near a rear edge of the panel.

Preferably, the track further comprising a plurality of notches that are spaced at pre-determined positions and are adapted to engage the fastening means. The notches on the track of the first panel correspond to those positions of the notches on the track of the opposing second panel.

Preferably, the fastening means is any one selected from the group: a releasable latch, a lever lock, a stud, a protuberance, a snap or clip fit arrangement.

Preferably, the display or storage means is any one selected from the group: a crossbar, a shelf.

Preferably, the display or storage means is integral with the fastening means, i.e. they both either are adapted to engage with each other or are formed in a single article.

Preferably, the panel has a hollow cavity. More preferably, the hollow cavity of the panel houses an illuminating device. Alternatively, the hollow cavity of the panel houses a communicator for obtaining product information from products on the display or storage means, and transmitting the information to a processor. Such communicators may include any device that may be part of a network that obtain product information from products placed on the display or storage means. For example, the device may pick up data provided by sensors on the products allowing the network to determine if re-stocking of the products on the display or storage means is necessary. In addition, or as an alternative, the communicators may be any sensor that may pick up information such as customer presence and/or traffic (for example when the sensor is a heat sensor) in the vicinity of the display or storage means and send that information to a processor for processing and analyzing the information. Such communicators may also include image capturing devices. All the communicator devices may communicate information to a processor either by wire or wireless (for example, by Wifi®, Bluetooth® etc.)

Preferably, the panel further comprises slots on a front edge of the panel for receiving a display means.

Preferably, the bottom end of the panel is supported on the ground by a base.

In a second aspect of the invention, there is provided a kit for erecting a furniture system, the kit comprising: (a) a prefabricated first panel having at least one track on a surface of the panel, the track running the length of the panel; (b) a prefabricated display or storage means adapted to slide along the length of the track; and (c) a prefabricated fastening means for securing the display or storage means at a desired position along the track; and optionally having instructions for erecting the furniture system.

Preferably, the kit further comprises: (a) a prefabricated second panel opposing the first panel; (b the second prefabricated panel having at least one track on a surface that opposes the first vertical panel, the track running the length of the panel; and (c) the prefabricated display or storage means extends between the first and second panels.

Advantageously, the present invention provides a modular furniture system that allows a store or office to quickly and easily arrange furniture for display or storing products without the use of complicated parts. As such, it allows flexibility in the design of the space because of its modular system and, because it is a vertical free-standing system, it does not require the use of any walls for support.

### BRIEF DESCRIPTION OF FIGURES

In order that the present invention may be fully understood and readily put into practical effect, there shall now be described by way of non-limitative examples only preferred embodiments of the present invention, the description being with reference to the accompanying illustrative figures.

In the Figures:

FIG. 1 is perspective view of the furniture system as set-up according to an embodiment of the present invention;

FIG. 2 is a perspective view of the panel according to an embodiment of the present invention;

FIGS. 3 and 3(a) are cross-section diagrams of the panel according to various embodiments of the present invention;

FIG. 4 is a perspective view of the panel according to an embodiment of the present invention;

FIG. 5 is a perspective view of the display or storage means according to an embodiment of the present invention; and

FIGS. 6(a) to (f) are perspective views of various examples of the fastening means according to an embodiment of the present invention.

### DETAILED DESCRIPTION OF THE PREFERRED EMBODIMENTS

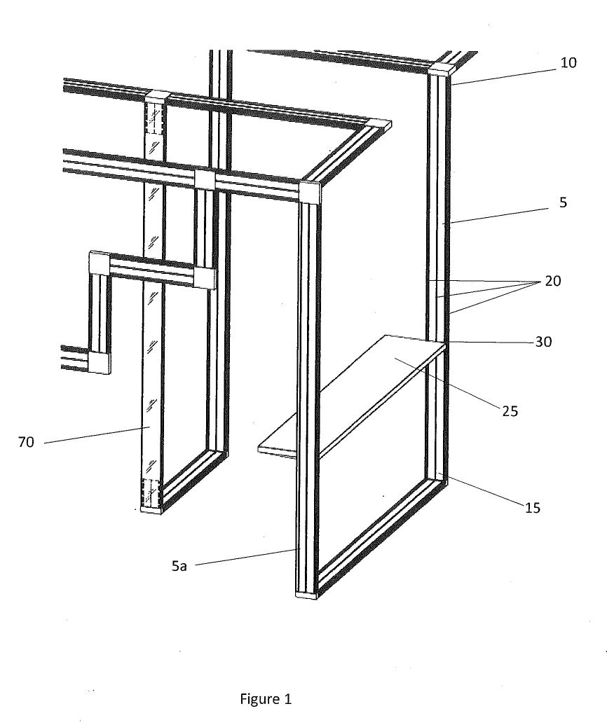

FIG. 1 shows an embodiment of the present invention. In particular, it shows the set-up of modular furniture system in accordance with an embodiment of the present invention.

In the simplest form of the present invention, the modular furniture system comprises a first panel 5. In an embodiment of the invention, as shown in the Figures, the panel 5 may be vertical. For ease of description, the panels will be described as vertical panels. However, these panels may be orientated in any direction. The vertical panel 5 has a top end 10 and a bottom end 15. On one surface of the vertical panel 5, there is at least one vertical track 20 running the length of the panel 5. For example, as shown in the Figures, the track 20 runs from the top of the panel 10 to the bottom of the panel 15. In FIG. 1, there is shown 3 vertical tracks 20. These tracks will be described in detail later. However, it is noted that the present invention may only require 1 track 20. A display or storage means 25 is adapted to slide along the length of the vertical track 20. A fastening means 30 may be any means that fastens and secures the display or storage means 25 at a desired position along the track 20. Various specific examples of the fastening means 30 will be described later.

By “furniture”, it is meant to include any object intended to support various human activities such as seating, sleeping, working, displaying and/or storing items of products either for sale or otherwise. Furniture is also used to hold objects at a convenient height for work (as horizontal surfaces above the ground), or to store things.

By “panel”, it is meant to include any piece of material that may be produced from an extrusion process. Such panels may typically be shaped into rectangular blocks of any desired size and made from a material that is structurally strong to support the weight of any article that may be placed on it. Preferably, the panel may be placed vertically, horizontally or diagonally.

By “display or storage means”, it is meant to include any means that allows for the display, placement and storage of any articles or products either for sale or otherwise. Such means may include fixture such as a shelf, a cross bar for hanging clothes hung on a hanger, or the like. By “shelf”, it includes any surface for placing products or be used as a work stations such as a table. By “fixture”, it is meant to include anything that may be permanent or temporary. In the present invention, by way of example, the placement (including the height of the) display or storage means is adjustable and may be moved along the track 20 of the panel and be secured at any position along the track 20. In addition, the term “display or storage means” is also meant to include any board for the display of graphics, pictures, information (for example, “point of purchase material” such as product information and price tags), and the like. These boards may include graphics that contribute to the “mood” or theme of the campaign for the sale of the products placed on the display or storage means.

By “track”, it is meant to include any narrow strip or conduit that is cut into the surface of the panel 5, 5a that is continuous and runs the length of the panel that allows the display or storage means 25 to slide along the length of the track. Alternatively, the track may be broken along the length of the panel 5, 5a in any suitable length or sections.

In another embodiment of the present invention, there is a second vertical panel 5a that is placed opposite the first vertical panel 5. The second vertical panel 5a may be similar or identical in features to the first vertical panel 5. Like the first vertical panel 5, the second vertical panel 5a has a top end 10 and a bottom end 15. The second vertical panel 5a also has at least one vertical track 20 on a surface that opposes (or facing) the first vertical panel 5, the track 20 running from the top of the panel 10 to the bottom of the panel 15. The display or storage means 25 extends between the first 5 and second 5a vertical panels.

By “extends”, it is meant that the length of the display or storage means 25 extends between the length or distance between the first 5 and second 5a vertical panels. It is also meant to include any display or storage means 25 that does not extend the entire length or distance between the first 5 and second 5a vertical panels. The length of the display or storage means 25 may be shorter than the length or distance between the first 5 and second 5a vertical panels, i.e. extends part of the length or distance between the first 5 and second 5a vertical panels.

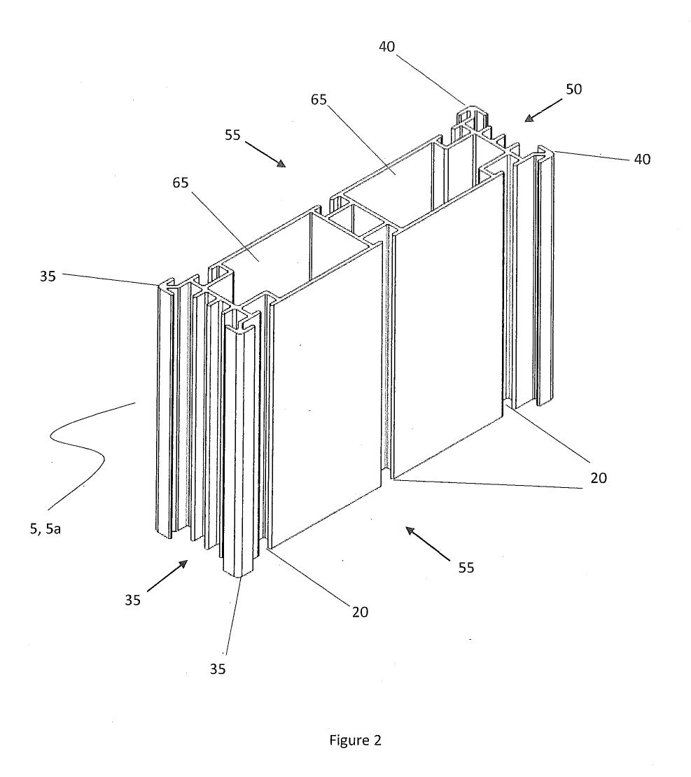

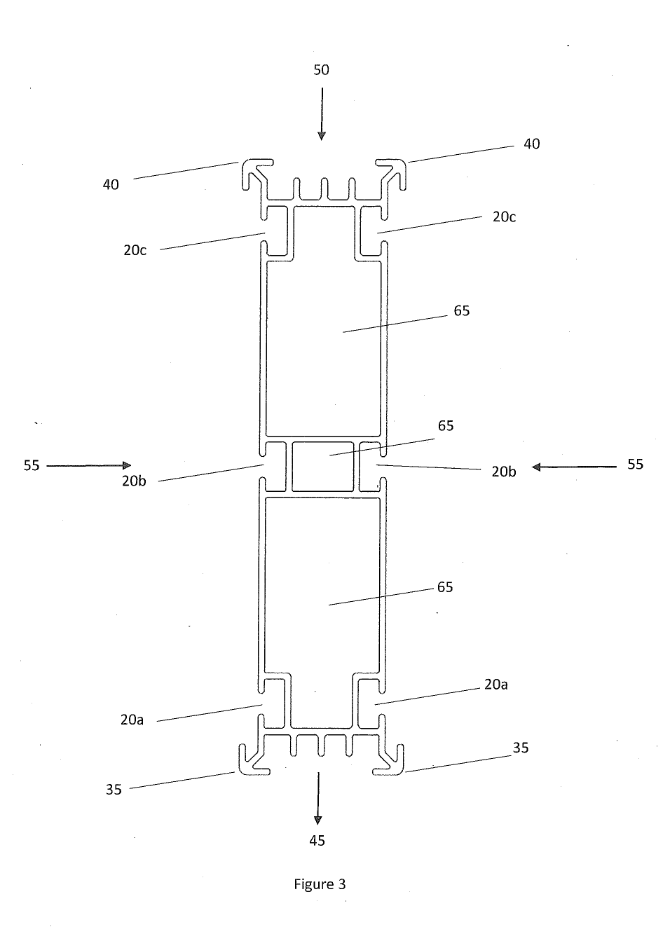

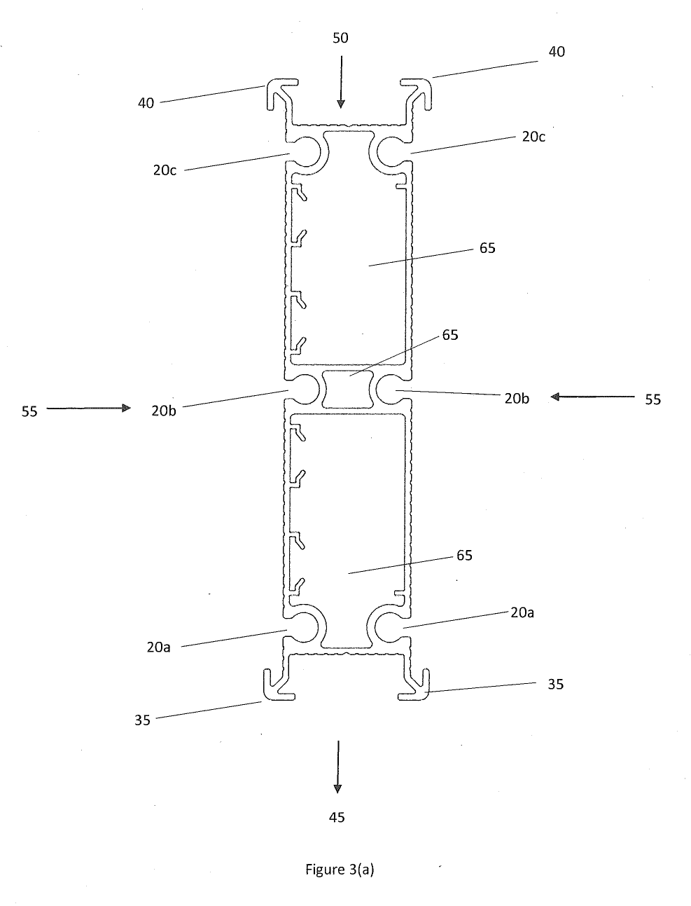

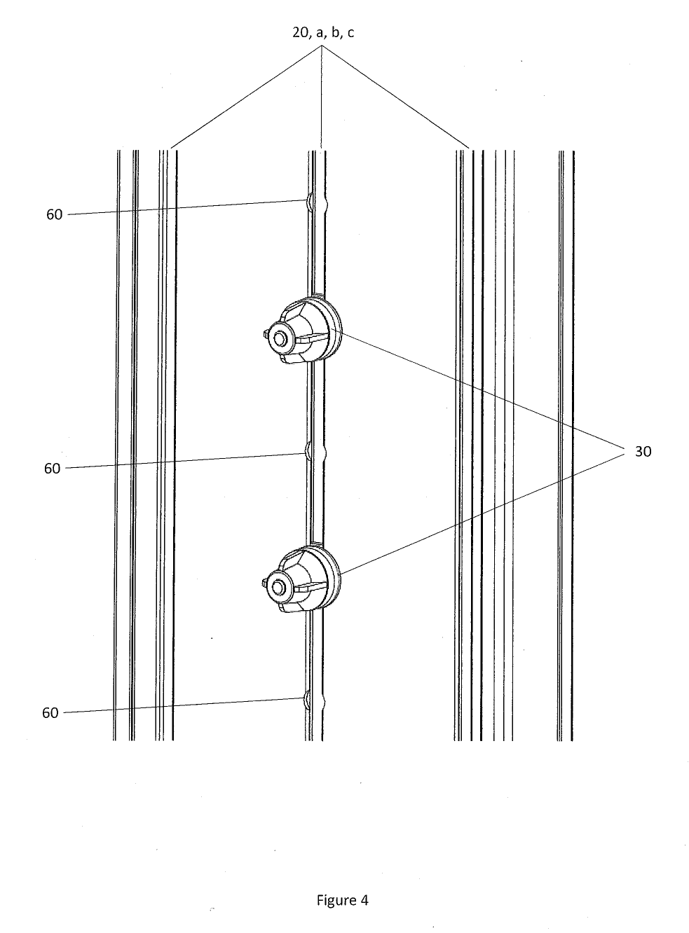

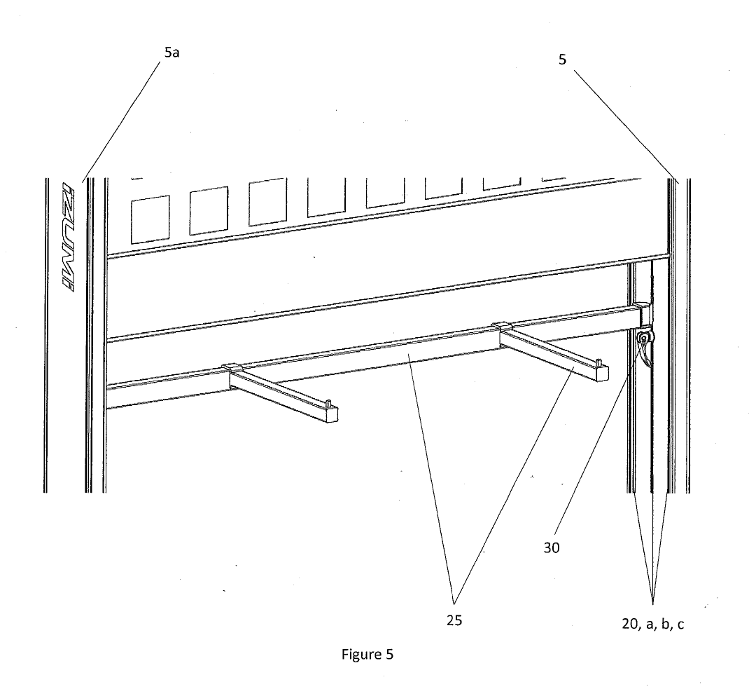

FIGS. 2 and 3 show perspective and cross-sectional views of the vertical panels 5 and 5a. FIG. 3(a) shows a cross-sectional views of the panel 5, 5a in another embodiment. Two key differences between the embodiments shown in FIGS. 3 and 3(a) are the rounded tracks 20a, b, c and brackets 75. The rounded tracks 20a, b, c are designed to accommodate the rounded profile of the fastening means 30 when it moves along the length of the track. The brackets 75 are used to accommodate lighting features 70 (for example, LED strips), including other electrically cables as desired. These embodiments will be described in detail below.

As described above and as shown in the Figures, an embodiment of the present invention includes having 3 tracks 20a, b, c on each first 5 and second 5a vertical panels. Advantageously, having 3 tracks on a side of the panel 5, 5a allows for a “layering” effect when displaying products and/or graphics and imagery. For example, a visually attractive environment may be created for a product in order to attract a consumer or a customer to buy the product. The front track 20a may accommodate a signage board to display information about the product including its price. The centre track 20b may accommodate the display or storage means 25 to display the product to a consumer. The rear-track 20c may accommodate a “mood graphic” which may set the tone of the advertising campaign that is targeted at selling the product. This “mood graphic” can include any imagery or a plain solid colour that is in line with the brand and advertising campaign of the product being sold (placed on the display or storage means 25). These 3 elements contribute to visual merchandising. Having said that, these tracks 20a, b, c may be used interchangeably to accommodate any one of the above 3 elements providing the flexibility in being creative when selling a product. The width or distance separating the tracks 20a, b, c may be any distance desired in a creating the visually attractive environment.

In the cross-sectional view of the vertical panel 5, 5a as shown in FIG. 3, it can be seen that the vertical panel 5, 5a has a 4 edges—2 front edges 35 and 2 rear edges 40. It follows then that it has a front surface 45, a rear surface 50, and 2 side surfaces 55. For the ease of description, the panels have been described to have front and rear sides. However, it is understood that these description will depend ultimately on the orientation of the panel and these terms may be used interchangeably. The tracks 20 are positioned on both side surfaces 55 of the vertical panel 5, 5a. The side surfaces 55 have a larger surface area than the front and rear surfaces 45, 50. In an embodiment where there are 3 tracks 20, one track is positioned in the center of the panel 20a, one track is positioned near a front edge of the panel 20b, and one track is positioned near a rear edge of the panel 20c. The positions of the tracks 20 on the first vertical panel 5 correspond to those positions of the tracks 20 on the opposing second vertical panel 5a.

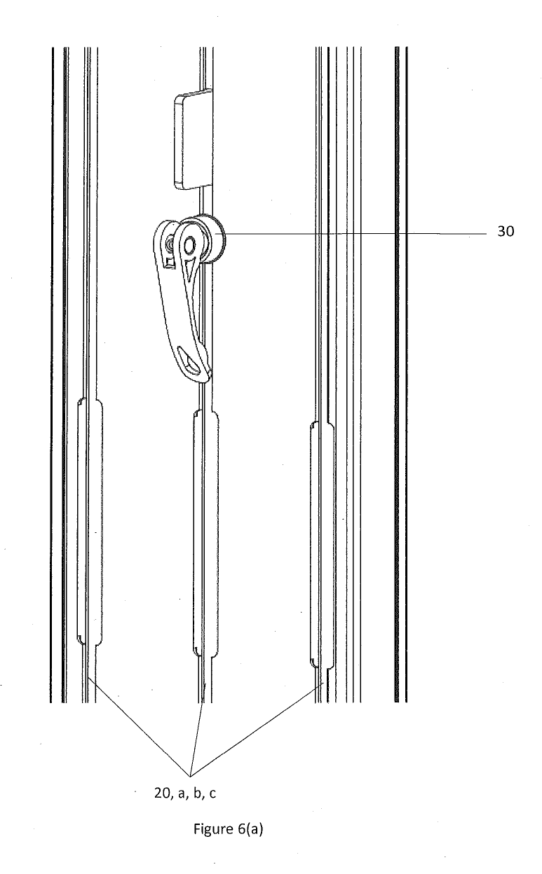

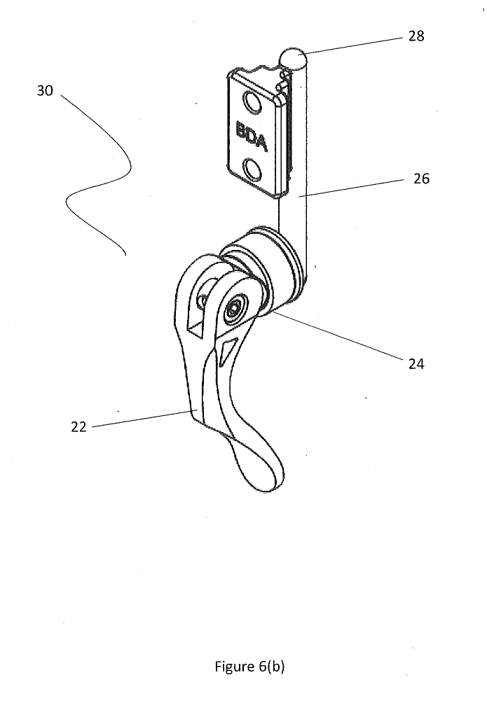

In an embodiment of the invention, there are tracks 20 on both side surfaces 55 of the vertical panel 5, 5a. As shown in FIG. 3, the position and location of the tracks 20 on both of the side surfaces 55 on the same panel 5 may be the same relative to each other. FIG. 3(a) shows another example of the vertical panel 5, 5a. Unlike the angular tracks 20 of the vertical panels 5, 5a shown in FIG. 3, the cross-section of the tracks 20 in FIG. 3(a) are rounded or circular in shaped. FIG. 4 shows a perspective view of the side 55 of the vertical panel 5, 5a. It shows that along each track 20 there is a series or plurality of notches 60 that are spaced at pre-determined positions and are adapted to engage the fastening means 30. The notches 60 on the track 20 of the first vertical panel 5 correspond to those positions of the notches 60 on the track 20 of the opposing second vertical panel 5a.

By “notch”, it is meant to include any small cut, cut-out or marking on the track 20, anywhere along the length of the track 20. By having the positions of the notches 60 on the first panel 5 correspond to those same positions of the notches 60 on the opposing second panel 5a, these notches 60 act as markers so that any display or storage means that extends between the first 5 and second 5a vertical panels will be aligned level to the ground. In an embodiment of the invention, it can be seen in FIG. 4 that the notch 60 is a cut-out along the track 20 that is shaped like a circle that overlaps the track 20.

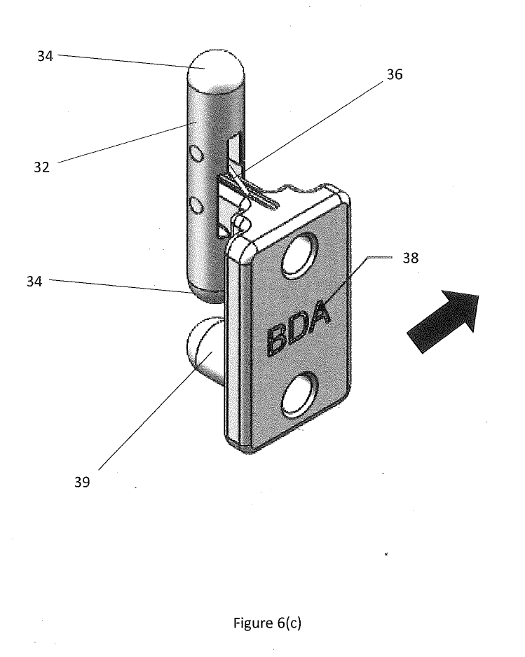

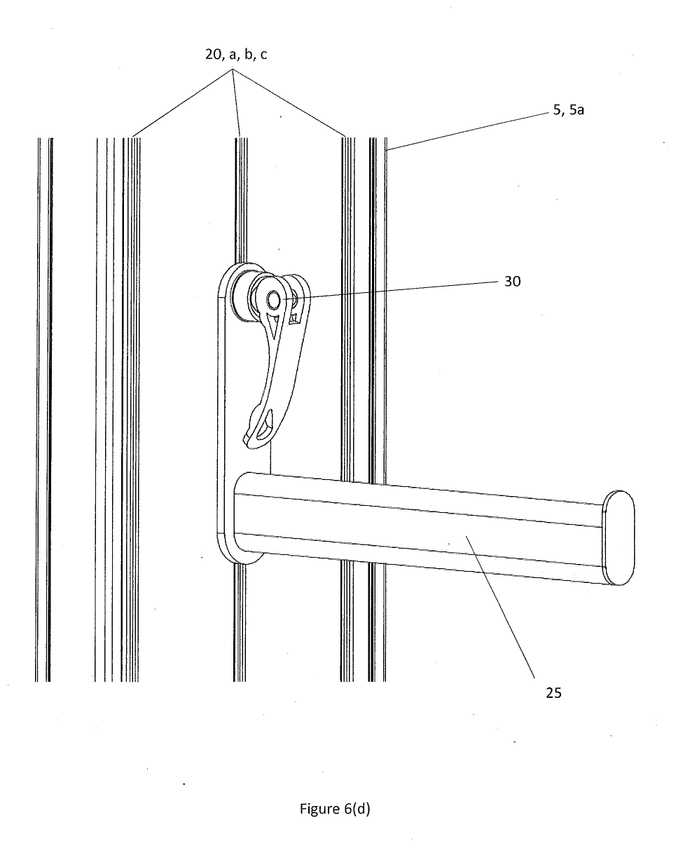

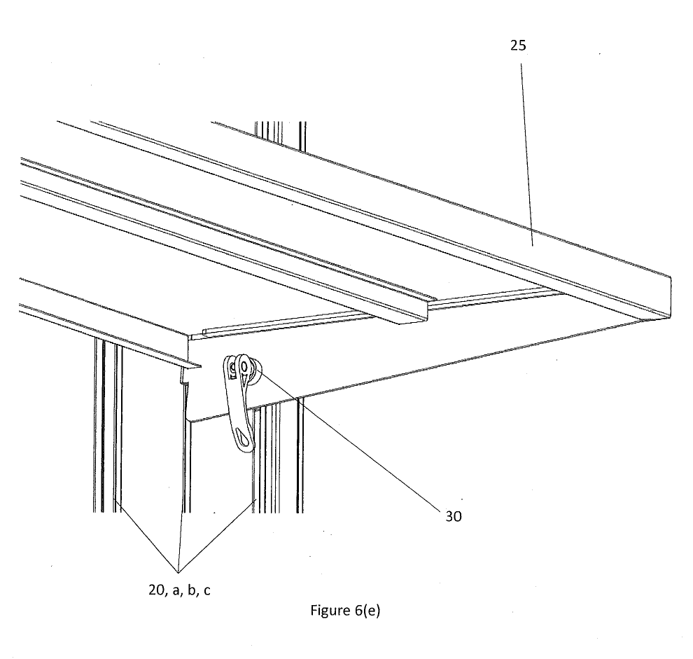

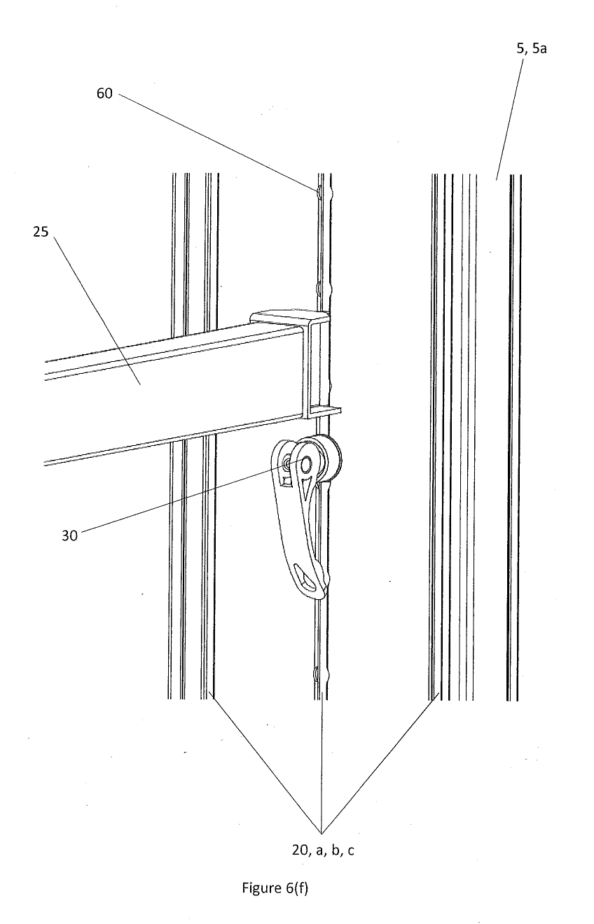

FIGS. 4, 6(a) to (f) show various examples of a fastening means 30. These include any one that is selected from the group: a releasable latch, a lever lock, a stud, a protuberance, a snap or clip fit arrangement. The fastening means 30 may be inserted into a track 20 from one end of the length of the track 20. This allows the fastening means 30 to slide anywhere along the length of the track 20. The releasable latch may include any biasing means to allow the fastener to stay on the track 20 by frictional forces. FIGS. 6(a) and 6(b) show an example of a lever lock as a fastening means 30. The lever lock comprises a longitudinal rod 26 that engages the track and a lever 22 that pivots about a neck 24 allowing the neck to tighten or loosen its grip on the track 20. The lever 22 acts as a locking mechanism. The rod 26 may be any shape so long as it allows the fastening means 30 to slide along the length of the track 20. In the present case, the rod 26 is cylindrical in shape so that it engages the track 20 of the panel 5, 5a as shown in FIGS. 3 and 3(a). Advantageously, the mating of the cylindrical shape of the rod 26 of the fastening means 30 with the circular track 20 allows for the smooth sliding of the fastening means 30 along the track 20 since less friction is encountered between the two surfaces. In addition, one end 28 of the rod 26 may be rounded allowing easy insertion of the fastening means 30 into the track 20. Alternatively, both ends of the rod 26 may be rounded so that friction is reduced when the rod 26 is moving in either direction.

FIG. 6(c) shows another example of the fastening means 30 that has as a snap or clip fit arrangement. Similar to the fastening means 30 shown in FIG. 6(a), the fastening means 30 has a rod 32 that engages and slides along the track 20 of a panel 5, 5a. The rod 32 has two ends 34 that are rounded for easy insertion into the track 20. Once again, the rod 32 may be shaped in any shape or configuration for easy mating with the track 20. A biasing means 36 is biased in the locked position of the fastening means 30. By lifting the tab 38 in the direction of the arrow shown in the Figure, the fastening means 30 is in an unlocked position and allows it to slide anywhere along the length of the track 20. A stud 39 may engage a notch 60 on the track 20 for fastening and/or positioning.

As shown in FIGS. 6(e) and (f), the fastening means 30 is adapted to engage the display or storage means 25 such that it locks the display or storage means 25 in place along the track 20. The fastening means 30 may be attached to the display or storage means 25 by welding or any other means known to the skilled person. In FIG. 6(e), the display or storage means 25 may be a shelf or table surface which requires 2 fastening means 30 (which is a lever lock in this example). The fastening means 30 may be positioned on the same level or plane on more than one track (e.g. two tracks 20 as shown in FIG. 6(e)) and engage the display or storage means 25 mechanically and secures the display or storage means 25. In FIG. 6(f), the display or storage means 25 is a cross bar. The cross bar may be used to display or store clothes hung on hangers. In FIG. 5, the display or storage means 25 may comprise a cross bar and further bars attached perpendicular to the cross bar for displaying or storing clothes hung on hangers. Of course, the invention is not limited to only displaying or storing clothes, but may include the hanging of any product or items for display or storage.

In an embodiment of the invention, the display or storage means 25 is integral with the fastening means 30, i.e. they both either are adapted to engage with each other or are formed in a single article. This can be seen in FIG. 6(b) where the fastening means 30 is integral to the display or storage means 25 (cross bar in this case).

Returning to FIG. 3 that shows the cross section of the vertical panels 5, 5a, it can be seen that the panel has a cavity or a hollow 65. In an embodiment of the invention, the inside of the panel 5, 5a is divided into several sections—each section represents a hollow 65 interior. In one embodiment of the invention, the hollow 65 interior may house an illuminating device, for example a light bulb, a light tube, LED tubing, and the like. Tabs 62 (as shown in FIG. 3(a)) in the hollow cavity allow for easy placement of the illuminating device.

In an alternative embodiment, the hollow cavity 65 may be adapted to house utility cables such as power electrical cables, telephone wires, cables for providing cable television or broadband internet access, or the like. In addition, the hollow cavity 65 may include a piping infrastructure for piping water and air. There may be any suitable cut-outs along the length of the panel 5, 5a for allowing access to such utility cables and pipes. In a further embodiment of the present invention, the panel 5, 5a may be a structural wall or part of a structural wall of a building capable of supplying utility cables, water and air to occupants of the building.

In addition to the above or in an alternative embodiment of the invention, the hollow cavity 65 of the vertical panel 5, 5a houses a communicator for obtaining product information from products on the display or storage means 25, and transmitting the information to a processor. Such a system of relying product information is useful so that an inventory of the products on the display or storage means 25.

With reference to FIGS. 3 and 3(a), the front edges 35 and rear edges 40 may have flanges (brackets) such that the surfaces 45, 50 and 55 can receive a display means such as a board. Such a display board may be used to decorate the sides of the vertical panels 5, 5a. This is particularly useful in a retail store where the display means such as a board may be used as advertisements, displaying product information and/or contribute to the aesthetics and branding of the store.

The panel 5, 5a may be made of any durable material that may be opaque or non-opaque. For example, in the embodiment where the display or storage means 25 is a shelf or a cross bar, the panels 5, 5a can support a weight of about 150 kg placed on a 1.2 m shelf or hung on a 1.2 m crossbar. In the case where the panel is made from a non-opaque material, light from the hollow 65 interior may be seen from outside or surroundings of the panel. The light may then be used to illuminate the display means board described above. In an embodiment of the invention, the display means board may be made of any non-opaque material such as polycarbonate or acrylic sheets. If illumination is not desired, then the boards may be opaque made from materials such as laminate, PVC, leather, fabric, wood, foam etc. The panels 5, 5a might be of any suitable colour or laminate. An example of how light is may be seen from the exterior of the panel is shown as feature 70 in FIG. 1. Light from an illuminating device in the hollow 65 interior of the panel 5, 5a may be seen being emitting from the side 55 of the panel 5, 5a.

The bottom end 15 of the vertical panel 5, 5a may be supported on the ground by a base. Alternatively, first 5 and second 5a vertical panels may be connected to a horizontal panel (that has the same technical features of the vertical panel 5, 5a but placed horizontally) to form a frame or part of a frame. Any suitable number of joints (or connectors) may be used to join the panels 5, 5a to form the frame.

Finally, the present invention also provides a kit for erecting a furniture system as shown in FIG. 1 wherein the kit comprises all the components described above. In particular, it comprises a prefabricated first vertical panel 5 having at least one vertical track 20 on a surface of the panel 5 running from the top of the panel 10 to the bottom of the panel 15, a prefabricated display or storage means 25 that is adapted to slide along the length of the track 20, a prefabricated fastening means 30 for securing the display or storage means 25 at a desired position along the track 20, and instructions for erecting the furniture system.

In addition to the above, in an embodiment of the invention, the kit may further comprise a prefabricated second vertical panel 5a opposing the first vertical panel 5, the second prefabricated vertical panel 5a having at least one vertical track 20 on a surface that opposes the first vertical panel 5, the track 20 running from the top of the panel 10 to the bottom of the panel 15, and the prefabricated display or storage means 25 for extending between the first and second vertical panels 5, 5a.

Whilst there has been described in the foregoing description preferred embodiments of the present invention, it will be understood by those skilled in the technology concerned that many variations or modifications in details of design or construction may be made without departing from the present invention.

1. A modular furniture system, the system comprising:
(a) a first panel having at least one track on a surface of the panel, the track running the length of the panel;
(b) a display or storage means adapted to slide along the length of the track; and
(c) a fastening means for securing the display or storage means at a desired position along the track.

2. The system according to claim 1, further comprising:
(a) a second panel opposing the first panel;
(b) the second panel having at least one track on a surface that opposes the track of the first panel, the track running the length of the panel; and
(c) the display or storage means extends between the first and second panels.

3. The system according to of claim 1, wherein the first and second panels further comprising a plurality of tracks on the surface that opposes each other, each track is adapted to receive at least one display or storage means, wherein the display or storage means is adapted to slide along the length of the track.

4. The system according to claim 2, wherein each first and second panels comprising three tracks, the positions of the tracks on the first panel correspond to those positions of the tracks on the opposing second panel.

5. The system according to claim 4, wherein one track is positioned in the center of the panel, one track is positioned near a front edge of the panel, and one track is positioned near a rear edge of the panel.

6. The system according to claim 1, wherein the track further comprising a plurality of notches that are spaced at pre-determined positions and are adapted to engage the fastening means.

7. The system according to claim 6, wherein the position of the notches on the track of the first panel correspond to those position of the notches on the track of the opposing second panel.

8. The system according to claim 1, wherein the fastening means is any one selected from the group: a releasable latch, a lever lock, a stud, a protuberance, a snap or clip fit arrangement.

9. The system according to claim 1, wherein the display and holding means is any one selected from the group: a crossbar, a shelf.

10. The system according to claim 1, wherein the display or storage means is integral with the fastening means.

11. The system according to claims 1, wherein the panel has a hollow cavity.

12. The system according to claim 11, wherein the hollow cavity of the panel houses an illuminating device.

13. The system according to claim 11, wherein the hollow cavity of the panel houses a communicator for obtaining product information from products on the display or storage means, and transmitting the information to a processor.

14. The system according to claim 1, further comprising slots on a front edge of the panel for receiving a display means.

15. The system according to claim 1, wherein the bottom end of the panel is supported on the ground by a base.

16. A kit for erecting a furniture system, the kit comprising:
(a) a prefabricated first panel having at least one track on a surface of the panel, the track running the length of the panel;
(b) a prefabricated display or storage means adapted to slide along the length of the track; and
(c) a prefabricated fastening means for securing the display or storage means at a desired position along the track; and
optionally having instructions for erecting the furniture system.

17. The kit according to claim 16, further comprising:
(a) a prefabricated second panel opposing the first vertical panel;
(b) the second prefabricated panel having at least one track on a surface that opposes the first panel, the track running the length of the panel; and
(c) the prefabricated display or storage means extends between the first and second panels.
